(19) United States
(12) Patent Application Publication
(10) Pub. No.: US 2005/0212616 A1
(43) Pub. Date: Sep. 29, 2005

(54) Radiowave receiving device

(75) Inventors: Cheng-Nan Lee, Taipei Hsien (TW); Wei-Ya Liao, Taipei Hsien (TW)

Correspondence Address: RATNERPRESTIA, P O BOX 980, VALLEY FORGE, PA, 19482-0980, US

(73) Assignee: Wistron Neweb Corporation

(21) Appl. No.: 11/080,152

(22) Filed: Mar. 15, 2005

(30) Foreign Application Priority Data
Mar. 26, 2004 (TW) 93108300

(51) Int. Cl. H01P 5/103

(52) U.S. Cl. 333/26; 333/33

(57) ABSTRACT

A radiowave receiving device including a waveguide, a probe, a circuit, and an impedance matching mechanism. The waveguide has a cavity for conveying radiowave. The probe, disposed in the cavity, converts radiowave conveyed by the waveguide into a circuit signal. The circuit, electrically coupled to the probe, receives the circuit signal. The impedance matching mechanism provides the waveguide with an impedance match with respect to the circuit. Affixed to the waveguide, the impedance matching mechanism includes a tuning element in a spatial position.

### CROSS REFERENCE TO RELATED APPLICATIONS

This application claims the right of priority based on Taiwan Patent Application No. 093108300 entitled “Radiowave Receiving Device”, filed on Mar. 26, 2004, which is incorporated herein by reference and assigned to the assignee herein.

### FIELD OF INVENTION

The present invention relates to a radiowave receiving device and to an impedance matching device for a RF signal transmission system.

### BACKGROUND OF THE INVENTION

One of the most popular applications of satellite antenna is Direct Broadcast Satellite TV (DBS-TV). The satellite signals are collected by a disk antenna, reflected to a low noise block down converter with feedhorn (LNBF) on the focal point of the disk antenna, and then amplified by a low noise amplifier. The LNBF transforms the signals in the carrier frequency (ex. 12 GHz) into Intermediate Frequency (IF), and then the signals will be received by the Set-Top Box and finally be lowered to 0˜6 MHz baseband for the TV set.

Typically, an additional element is employed in the circuit to provide a proper impedance match to reduce the noises generated by aforementioned processes. Taking the microstrip circuit 10 of the prior art shown in FIG. 1 for example, metal tabs 12 and metal tabs 14 are soldered alongside the transmission line to adjust the desired impedance. A more sophisticated method is found in U.S. Pat. No. 4,618,838 in which the impedance of the microstrip circuit for RF signals can be adjusted. The microstrip circuit includes a conductive wire element. One end of the wire element is fixed on the microstrip circuit substrate, and the other end is freely moving above the transmission line, so that the impedance can be adjusted.

Additionally, in U.S. Pat. No. 5,357,225, an interdigital capacitor is provided including a plurality of conductive and dielectric finger regions. The first finger region is coupled to the microstrip transmission line and the second conductive finger region is coupled to ground. The individual conductive fingers of the first conductive region are located parallel and interspersed with the individual conductive fingers of the second conductive finger region. Because the individual fingers of the conductive finger region provide a predetermined level of impedance to the interdigital capacitor, the value of the interdigital capacitor can be adjusted by removing one or more individual conductive fingers. This in turn provides a known response in the phase of a signal traveling on the microstrip transmission line.

It is known that noises increase as signals are amplified. If the noises are reduced in the beginning, the amplified output signals will have the improved quality, and the cost to control the succeeding noises will be lowered. Yet the methods and the devices described above have controlled noises of the transmitted signals along the transmission lines, but they didn't deal with the input signal in the beginning. Therefore, it is advantageous if a device is capable of decreasing the initial noises for a radiowave circuit device.

### SUMMARY OF THE INVENTION

One aspect of the present invention is to provide a radiowave receiving device of which the impedance is easily adjusted.

Another aspect of the present invention is to provide a radiowave receiving device of which the impedance is variable.

Still another aspect of the present invention is to provide a radiowave receiving device capable of lowering the noise for the initial input signal.

The present invention provides a radiowave receiving device including a waveguide, a probe, a circuit, and an impedance matching mechanism. The waveguide has a cavity for conveying the radiowave. The probe, disposed within the cavity, converts the radiowave conveyed by the waveguide into a circuit signal. The circuit, electrically coupled to the probe, receives the circuit signal. The impedance matching mechanism, integrated with the waveguide, provides the waveguide with an impedance match with respect to the circuit. The impedance matching mechanism includes a tuning element.

The present invention also provides an impedance matching device for a waveguide. The waveguide has a cavity wherein a probe is disposed. The probe receives the radiowave conveyed from the cavity and is coupled to a circuit for converting the radiowave into a circuit signal. The impedance matching device provides the waveguide with an impedance match with respect to the circuit. The impedance matching device also includes a tuning element.

The present invention further provides a radiowave receiving device including a waveguide, a probe, a circuit, and a tuning mechanism. The waveguide includes a cavity for conveying the radiowave. The probe, disposed within the cavity, converts the conveyed radiowave into a circuit signal. The circuit, electrically coupled to the probe, receives the circuit signal. The tuning mechanism, integrated with the waveguide, includes a reflection surface and a tuning element. The reflection surface extends into the cavity, and the tuning element adjusts a distance between the reflection surface and the probe.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates an impedance adjustment of a mircrostrip circuit according to the prior art;

FIG. 2 illustrates a radiowave receiving device in accordance with an embodiment of the present invention;

FIG. 3 illustrates a radiowave receiving device in accordance with another embodiment of the present invention;

FIG. 4 illustrates a radiowave receiving device in accordance with further another embodiment of the present invention;

FIG. 5 illustrates a radiowave receiving device in accordance with still another embodiment of the present invention;

FIG. 6 illustrates a radiowave receiving device in accordance with yet another embodiment of the present invention; and

FIG. 7 illustrates a radiowave receiving device in accordance with an additional embodiment of the present invention.

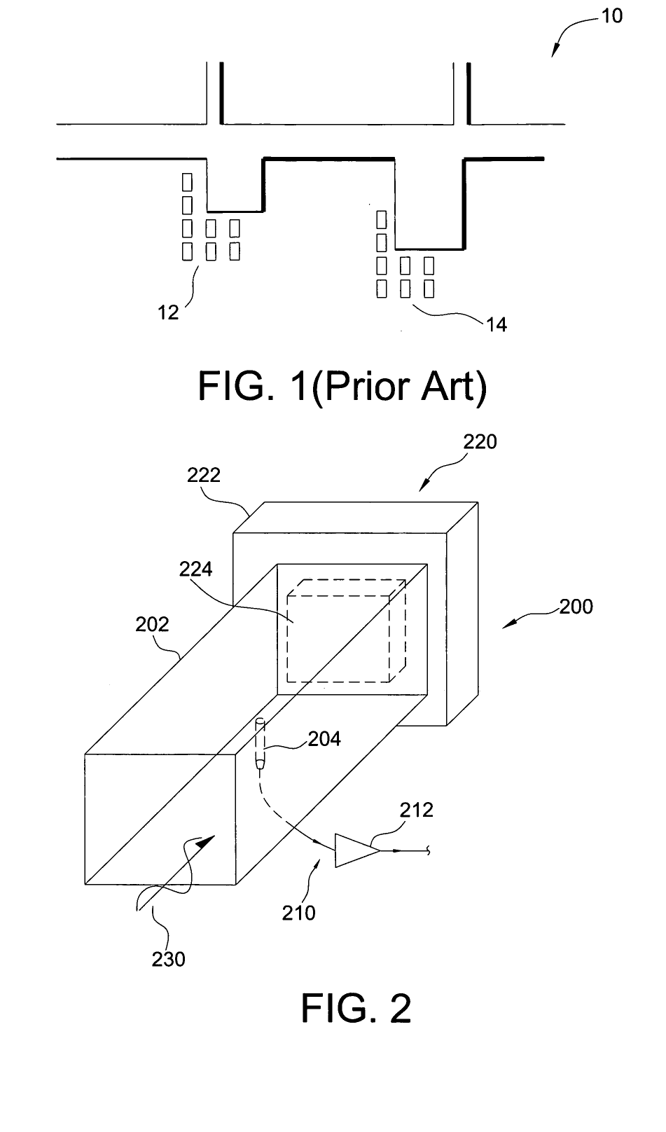

### DETAILED DESCRIPTION OF THE INVENTION

The present invention presents a radiowave receiving device used in a RF signal transmission system for receiving a radiowave signal. In the following embodiments, the present invention is implemented with satellite signals within C band (4 GHz˜6 GHz) or Ku band (12 GHz˜14 GHz), and with electronic components for processing the satellite signals. However the devices or components described in the following are presented for the exemplary purpose, and are not intended to limit the scope of the present invention. It is also known to those skilled in the art that various modifications may be made without departing from what is covered by the present invention.

In FIG. 2, the radiowave receiving device 200 includes a waveguide 202, a probe 204, a circuit 210, and an impedance matching mechanism 220. In the waveguide 202, the cavity is provided for collecting and conveying the radiowave 230. The probe 204, disposed within the cavity, receives and converts the conveyed radiowave 230 into a circuit signal. For an embodiment of the invention, the waveguide 202 is a rectangular waveguide (i.e., the cross section is rectangular), and the probe 204 is bar-shaped. However, to those skilled in this art, it is known that probes in other shapes, for example, a T-shape probe, are within the scope of the present invention. The circuit 210 is electrically coupled to the probe 204 and receives the circuit signal. The circuit 210 further includes a low noise amplifier (LNA) 212 and other components for processing the circuit signal, such as processors, coders, decoders, modulators, mixers, filters, etc. These components may be connected via the microstrips. The impedance matching mechanism 220, which provides the waveguide 202 with an impedance match with respect to the circuit 210, includes a supporting base 222 and a tuning element 224. The impedance matching mechanism 220 is affixed to the waveguide 202 via the supporting base 222. The tuning element 224 is disposed in a spatial position in the cavity. Preferably, the material of the tuning element is metal or other conductive material. The impedance is adjusted by changing the spatial position of the tuning element 224 relative to the impedance matching mechanism 220. In another embodiment, by changing the spatial position of the tuning element 224 relative to the probe 204, the impedance is adjusted.

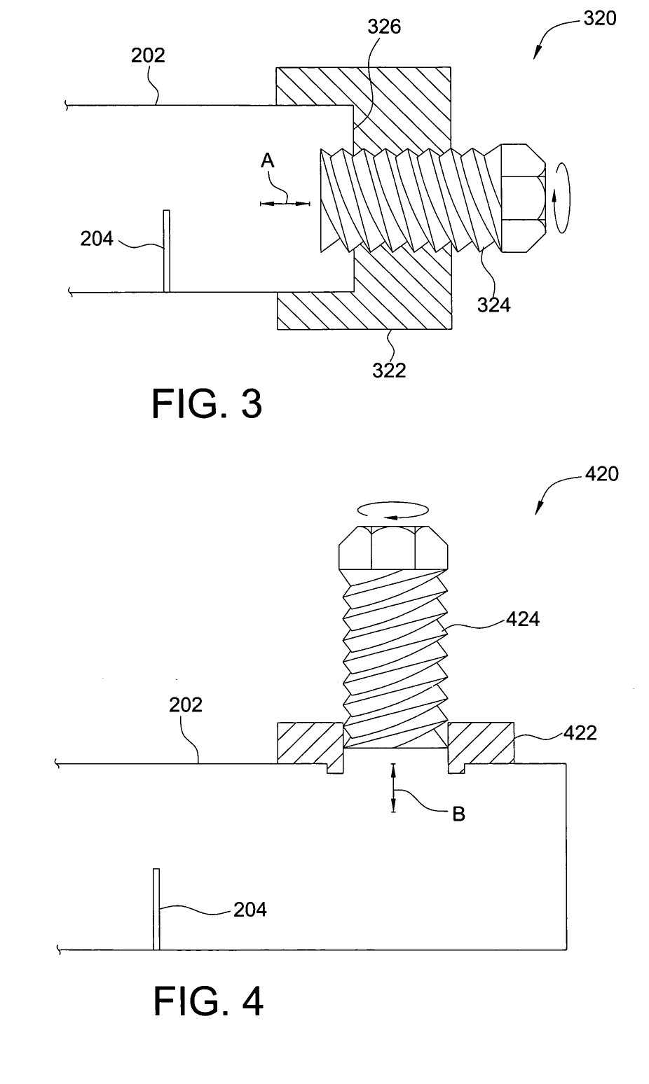

In FIG. 3, the impedance matching mechanism 320 is disposed at one end of the waveguide 202 via the supporting base 322. The impedance matching mechanism 320 includes a reflection surface 326 for reflecting the radiowave to the probe 204. The impedance matching mechanism 320 also includes a tuning element 324wherein the spatial position of the tuning element 324 is movable in a direction parallel to the longitudinal axis of the waveguide 202 (shown as A in FIG. 3). In an embodiment shown in FIG. 3, the tuning element 324 is a screw, and, by driving the screw, the screw selectively extends into or recedes from the cavity of the waveguide 202.

In FIG. 4, an impedance matching mechanism 420 is disposed on a wall of rectangular waveguide 202 via the supporting base 422, and the spatial position of tuning element 424 is movable in a direction (shown as B in FIG. 4) perpendicular to the longitudinal axis of the waveguide 202. In an embodiment, the tuning element 424 is a metal screw.

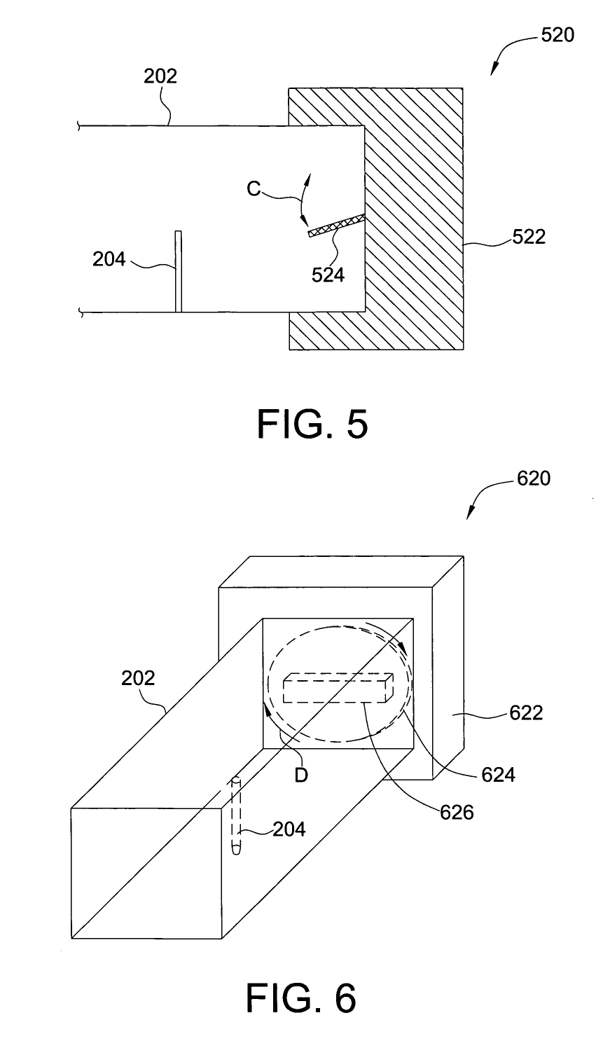

In FIG. 5, an impedance matching mechanism 520 is disposed at one end of the waveguide 202 via the supporting base 522. One end of the tuning element 524 is affixed to the impedance matching mechanism 520, while the other end of tuning element 524 can move freely in the cavity of waveguide 202, whereby the spatial position of tuning element 524 is changed relative to the impedance matching mechanism 520 or the probe 204. In an embodiment, the tuning element 524 is a metal wire.

Furthermore, the tuning element of the present invention can change the spatial position by being rotated correspondingly to a predetermined axis. An example can be shown in FIG. 6, in which the impedance matching mechanism 620 is disposed at one end of the waveguide 202 via the supporting base 622. The tuning element 624 has a rectangular portion 626. By rotating the tuning element 624 corresponding to an axis that parallels the longitudinal axis of the waveguide 202, the rectangular portion 626 is rotated (shown as D in FIG. 6) and the impedance is adjusted. In another embodiment (not shown), the tuning element is rotated correspondingly to an axis which is perpendicular to a longitudinal axis of the waveguide 202.

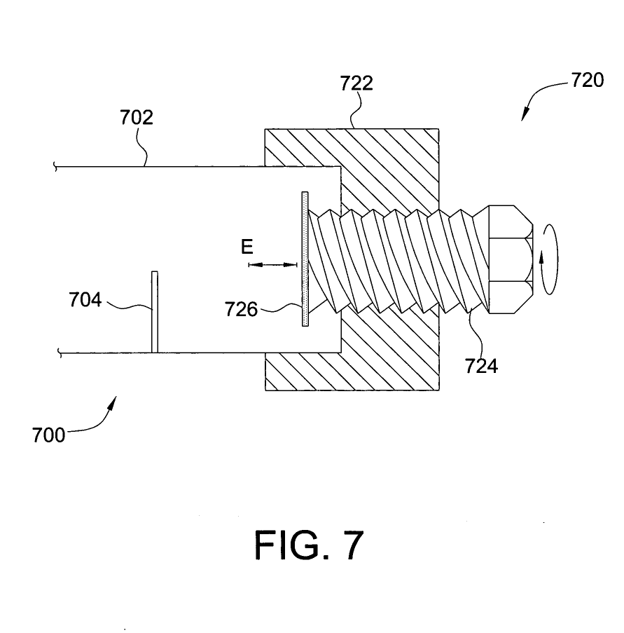

In FIG. 7, a radiowave receiving device 700 includes: a waveguide 702, a probe 704, a circuit, and a tuning mechanism 720. The tuning mechanism 720 includes a supporting base 722, a reflection surface 726, and a tuning element 724. The tuning mechanism 720 is affixed to waveguide 702 via the supporting base 722. The reflection surface 726 extends into the cavity of the waveguide 702. The tuning element 724 is disposed on the supporting base 722. The tuning element 724 is movable relatively to the supporting base 722, whereby a distance between the reflection surface 726 and the probe 704 can be adjusted. In an embodiment shown in FIG.7, the tuning element 724 is disposed on the supporting base 722 via a screw. By rotating the screw, the tuning element 724 is movable along “E” relatively to supporting base 722. In another embodiment, the tuning mechanism includes a screw hole, and the tuning element includes a screw. The reflection surface 726 is disposed at one end of the tuning element 724 and faces the probe. The distance between the reflection surface and the probe can be adjusted by rotating the tuning element.

Here the spatial position of the tuning element is changed via mechanical means, however, other electrical, magnetic, or thermal means for changing the spatial position also fall with the scope of the present invention. In addition, some components are not shown for simplifying the drawings and descriptions. For example, the waveguide may comprise two metal pieces separated by one printed circuit board.

While the present invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A radiowave receiving device, comprising:
a waveguide, said waveguide having a cavity for conveying a radiowave;
a probe disposed in said cavity for receiving the radiowave and converting the radiowave into a circuit signal;
a circuit electrically coupled to said probe for receiving the circuit signal; and
an impedance matching mechanism for providing said waveguide with a impedance match with respect to said circuit, said impedance matching mechanism being integrated with said waveguide and including a tuning element having a spatial position.

2. The radiowave receiving device of claim 1, wherein said impedance match is adjusted by changing the spatial position of said tuning element relative to said probe.

3. The radiowave receiving device of claim 1, wherein said tuning element selectively extends into or recedes from said cavity.

4. The radiowave receiving device of claim 1, wherein said tuning element is a screw.

5. The radiowave receiving device of claim 1, wherein said waveguide is a rectangular waveguide.

6. The radiowave receiving device of claim 5, wherein said spatial position is changed in a direction parallel to an axis of said waveguide.

7. The radiowave receiving device of claim 5, wherein said impedance matching mechanism is disposed at one end of said waveguide and includes a reflection surface to reflect the radiowave.

8. The radiowave receiving device of claim 7, wherein said tuning element is located at said reflection surface.

9. An impedance matching device, affixed to a waveguide having a cavity, said cavity accommodating a probe, said waveguide conveying a radiowave to said probe, said probe, coupled to a circuit, for converting the radiowave into a circuit signal, said impedance matching device providing said waveguide with an impedance match with respect to said circuit, said impedance matching device comprising a tuning element having a spatial position.

10. The impedance matching device of claim 9, wherein said impedance match is adjusted by changing the spatial position of said tuning element relative to said probe.

11. The impedance matching device of claim 9, wherein said tuning element selectively extends into or retreats from said cavity.

12. The impedance matching device of claim 9, wherein said tuning element is a screw.

13. The impedance matching device of claim 9, wherein said waveguide is a rectangular waveguide.

14. The impedance matching device of claim 13, wherein said spatial position is changed in parallel to an axis of said waveguide.

15. The impedance matching device of claim 13, wherein said impedance matching mechanism is disposed at one end of said waveguide and includes a reflection surface to reflect the radiowave.

16. The impedance matching device of claim 15, wherein said tuning element is disposed on said reflection surface.

17. A radiowave receiving device, comprising:
a waveguide, said waveguide having a cavity for conveying a radiowave;
a probe, disposed in said cavity, for receiving the radiowave and converting the radiowave into a circuit signal;
a circuit, electrically coupled to said probe, for receiving the circuit signal; and
a tuning mechanism integrated with said waveguide, said tuning mechanism comprising a reflection surface and a tuning element, wherein said reflection surface extends into said cavity, and said tuning element adjusts a distance between said reflection surface and said probe.

18. The radiowave receiving device of claim 17, said tuning mechanism comprising a supporting base to affix said tuning mechanism to said waveguide, wherein said tuning element is disposed on said supporting base and is slidable relatively to said supporting base.

19. The radiowave receiving device of claim 18, wherein said tuning element is disposed on said supporting base via a screw, and said tuning element is slidable relatively to said supporting base by rotating said screw.

20. The radiowave receiving device of claim 17, said tuning mechanism comprising a screw hole, said tuning element comprising a screw, said reflection surface disposed on one side of said tuning element and facing toward said probe, wherein a distance between said reflection surface and said probe is adjustable by rotating said tuning element.
